(19) United States
(12) Patent Application Publication
(10) Pub. No.: US 2017/0211478 A1
(43) Pub. Date: Jul. 27, 2017

(54) TUBULAR COOLER WITH INTEGRATED FAN

(71) Applicant: Unison Industries, LLC, Jacksonville, FL (US)

(72) Inventors: Michael Ralph STORAGE, Beavercreek, OH (US); Dennis MCQUEEN, Miamisburg, OH (US); Mark Phillip DRAKE, Kettering, OH (US); Maxime PEREIRA, Fonteanailles, Seine et Marne (FR)

(21) Appl. No.: 15/309,979

(22) PCT Filed: Apr. 11, 2014
(86) PCT No.: PCT/US2014/033739

§ 371 Date: Nov. 9, 2016

(51) Int. Cl. F02C 7/14; F02C 7/18; F02K 3/06

(52) U.S. Cl. CPC F02C 7/14; F02K 3/06; F02C 7/185; F05D 2260/213

(57) ABSTRACT

A tubular fin heat exchanger is provided with an integrated fan within the confines of a duct assembly. The tubular heat exchanger provides a structure and pathway to minimize space and weight of the integrated heat exchanger into the gas turbine engine.

### BACKGROUND

The present embodiments generally pertain to heat exchangers. More particularly, the present embodiments relate, without limitation, to assemblies of ducted tubular coolers with integral fans.

Turbine engines are utilized generally in the power industry to create energy which is utilized in communities' residential and commercial use, as well as powering aviation and marine crafts. These turbine systems may utilize heat exchangers in order to cool temperatures of fluids from within the turbine engine during operation.

During operation, significant heat is generated by the combustion and energy extraction processes with gas turbine engines. It is necessary to manage heat generation within the engine so as not raise engine temperatures to unacceptable levels, which may cause engine failure. One method of controlling heat and improving engine life is to lubricate engine components and cool lubricating fluids. In such heat exchanger embodiments, the air stream is utilized to cool the hot fluid of the turbine engine.

It would be desirable to improve aerodynamics and packaging of the heat exchanger cooling assemblies such that systems may improve air performance therein. This would eliminate the need for large volumes for existing coolers and reduce weight of the gas turbine engine.

Additionally, existing heat exchangers may utilize welded or brazed fin connections to structures wherein fluid may pass through for cooling. The process of brazing multiple fins along the fluid carrying ducts is time consuming tedious and very expensive for manufacturing.

It is desirable to provide a heat exchanger which is capable of being formed in non-traditional shapes. For example, many heat exchangers which utilize fin structures are not capable of being formed in an annular or tubular configuration due to the fin arrangement or the manifold or core of the heat exchanger.

In order to improve efficiency of gas turbine engine aircraft, a continuing goal is to reduce weight and provide cost savings associated with fan, fan motors, drive shafts and ducting. Additionally, this will result in lower fuel and operating costs. Additionally, it would be desirable to provide space and weight savings for aircraft airframe and other gas turbine engine applications. Reducing the weight and volume of these thermal management systems may result in improved efficiency of the aircraft or gas turbine engine.

The information included in this Background section of the specification, including any references cited herein and any description or discussion thereof, is included for technical reference purposes only and is not to be regarded subject matter by which the scope of the invention is to be bound.

### SUMMARY

According to present embodiments, a tubular fin heat exchanger is provided with an integrated fan within the confines of a duct assembly. The tubular heat exchanger provides a structure and pathway to minimize space and weight of the integrated heat exchanger into the gas turbine engine. A fan is additionally provided for connection to the duct or within the duct in order to provide desirable cooling over the heat transfer fins of the assembly.

According to some embodiments, a tubular cooler with integrated fan assembly comprises a duct having an inlet end and an outlet end, a heat exchanger disposed within said duct, the heat exchanger may have an annular shape and may extend axially at least partially between the first end and the second end of the duct. A fan is disposed in flow communication with the duct, the fan forcing airflow through the heat exchanger. The heat exchanger may comprise an extrusion core body in flow communication with a fluid inlet and a fluid outlet and, a plurality of fins extending from and integrally formed with the extrusion core body and positioned within the duct.

Optionally, the extrusion core body may have a plurality of circumferentially extending channels therein. The tubular cooler with integrated fan assembly may further comprise fins extending from one side of the extrusion core body or alternatively from two sides of the extrusion core body. The tubular cooler with integrated fan assembly may further comprise an outer flowpath and an inner flowpath corresponding to said fins extending from the two sides of the extrusion core body. The fan may be disposed in the duct or may be connected to the duct. The fan may be connected to one of the inlet end or the outlet end. Further, the fan may be disposed intermediate to the inlet and the outlet. The duct having a single heat exchanger therein or may have a plurality of the heat exchangers therein.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. A more extensive presentation of features, details, utilities, and advantages of the present invention is provided in the following written description of various embodiments of the invention, illustrated in the accompanying drawings, and defined in the appended claims.

### BRIEF DESCRIPTION OF THE ILLUSTRATIONS

The above-mentioned and other features and advantages of these exemplary embodiments, and the manner of attaining them, will become more apparent and the conformal heat exchanger for aircraft will be better understood by reference to the following description of embodiments taken in conjunction with the accompanying drawings, wherein:

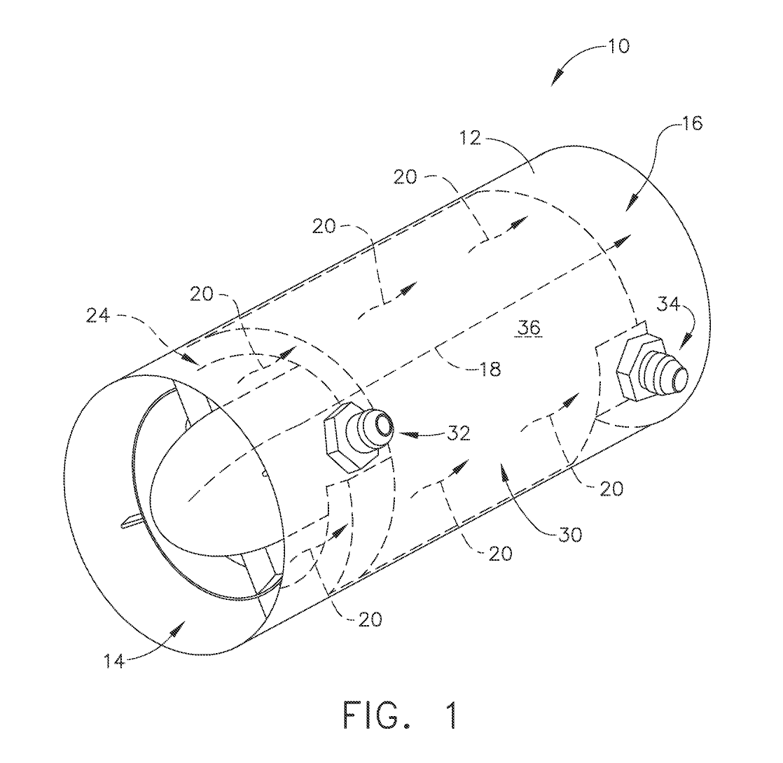

FIG. 1 is a perspective view of an assembly including inline heat exchanger and duct;

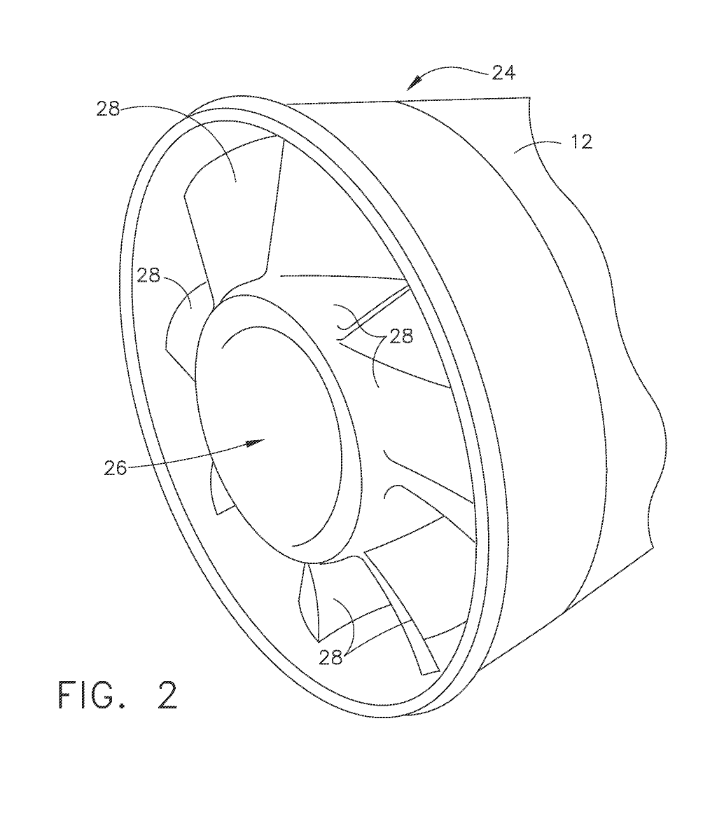

FIG. 2 is a perspective view of an exemplary axial fan;

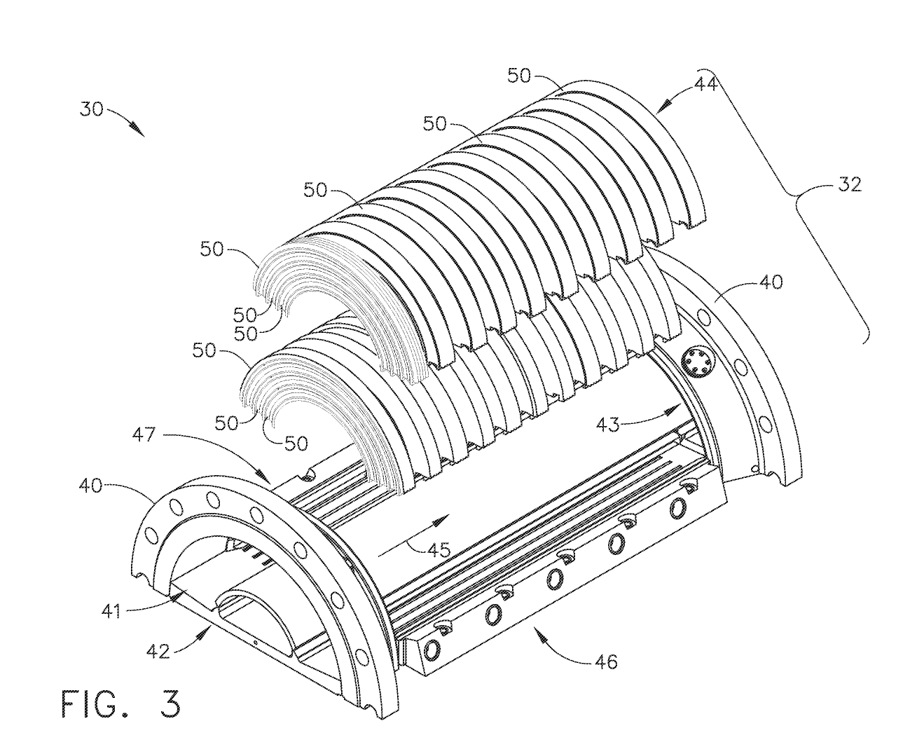

FIG. 3 is a portion of an exemplary heat exchanger for use in the assembly of FIG. 1;

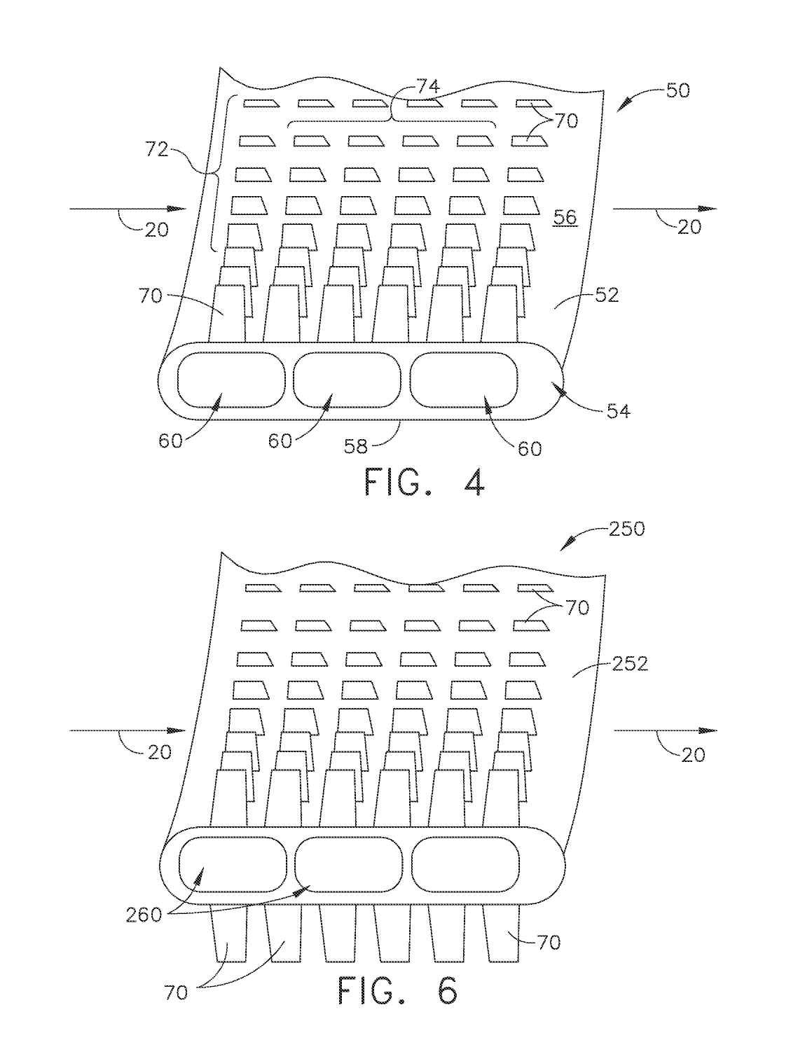

FIG. 4 is a circumferential view of an exemplary single sided fin heat exchanger;

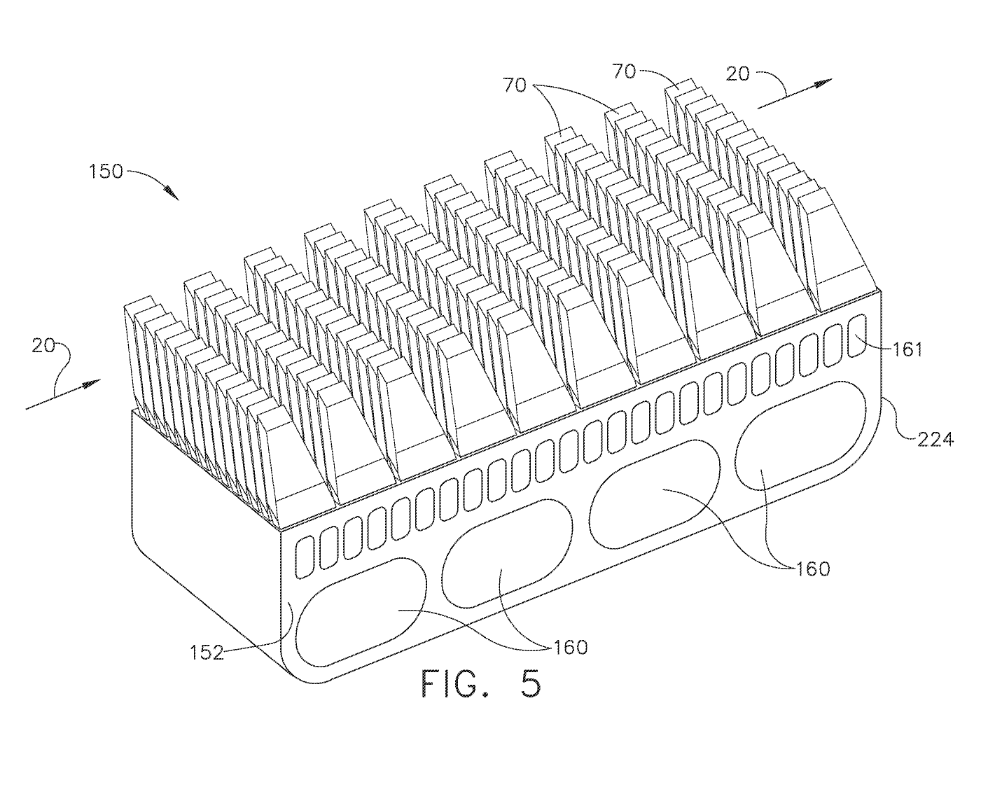

FIG. 5 is a circumferential view of an alternative single sided fin heat exchanger;

FIG. 6 is a circumferential view of an exemplary double sided fin heat exchanger;

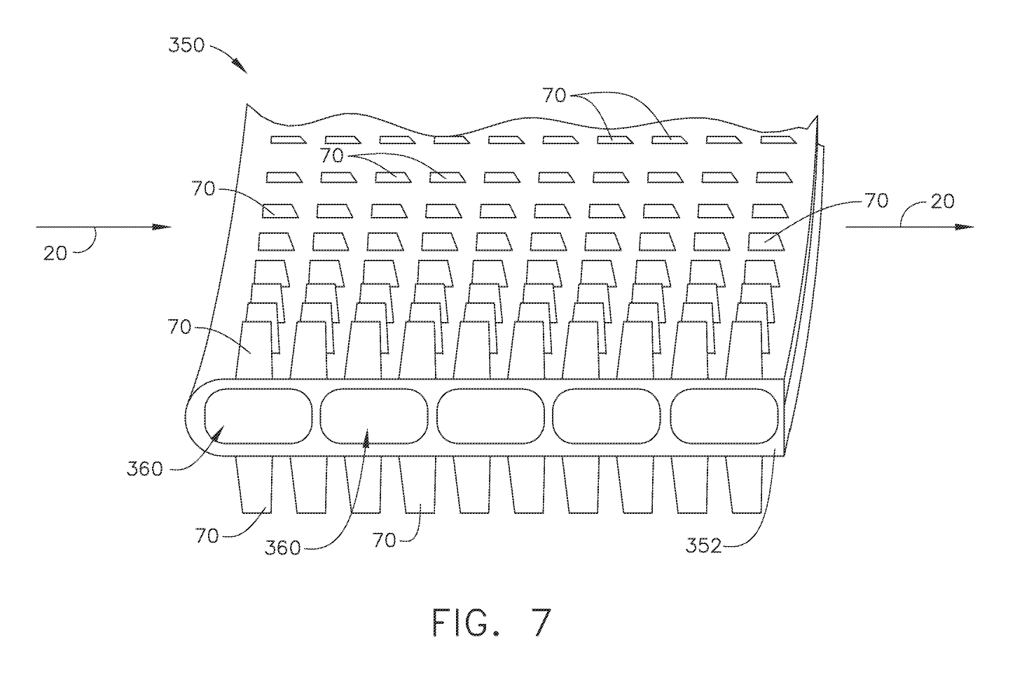

FIG. 7 is a circumferential view of an alternative double sided fin heat exchanger;

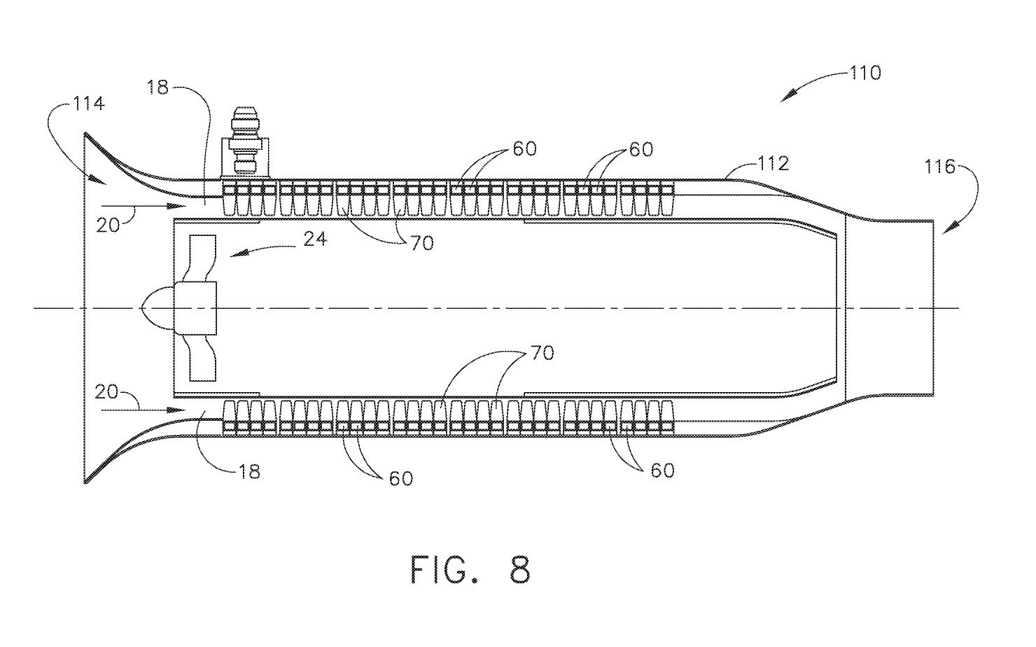

FIG. 8 is a side section view of a heat exchanger assembly including single-side fin arrangement; and,

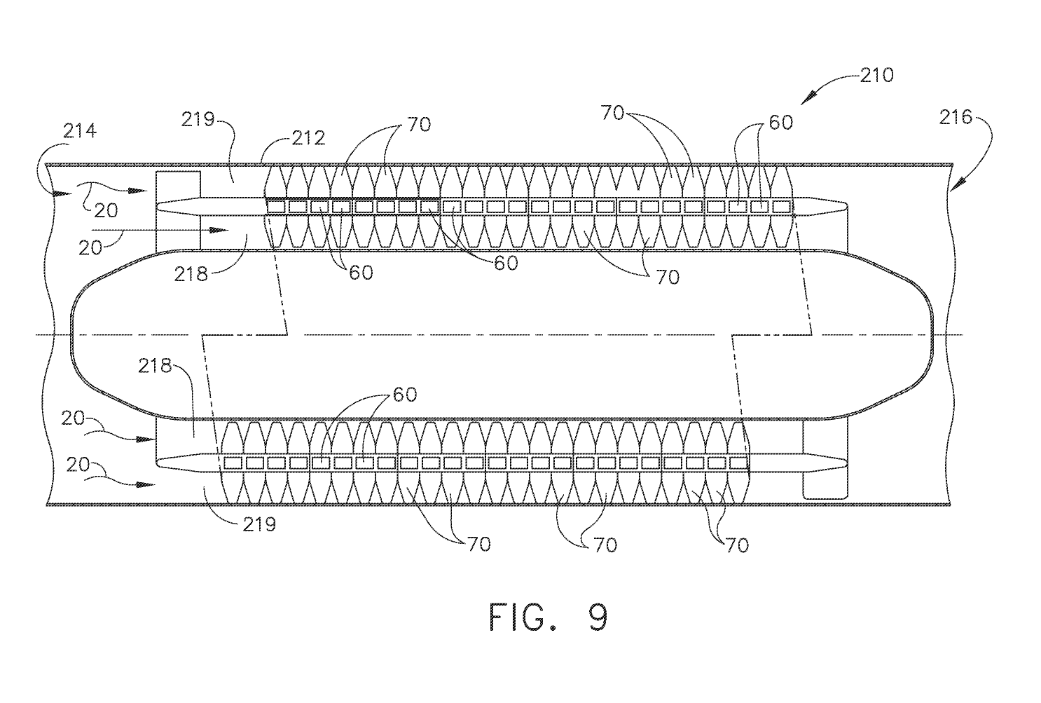

FIG. 9 is a side section view of a heat exchanger assembly including double-side fin arrangement.

### DETAILED DESCRIPTION

Reference now will be made in detail to embodiments provided, one or more examples of which are illustrated in the drawings. Each example is provided by way of explanation, not limitation of the disclosed embodiments. In fact, it will be apparent to those skilled in the art that various modifications and variations can be made in the present embodiments without departing from the scope or spirit of the disclosure. For instance, features illustrated or described as part of one embodiment can be used with another embodiment to still yield further embodiments. Thus, it is intended that the present invention covers such modifications and variations as come within the scope of the appended claims and their equivalents.

The heat exchanger is annular or circular in cross-section and is mounted coaxially within a tube and with an axial fan. The fan and heat exchanger are ducted to ensure air flows over the heat exchanger fins. The heat exchanger may be a single fin heat exchanger or a double fin heat exchanger.

Referring to FIGS. 1-9, various embodiments of a tubular heat exchanger with integral fan are shown. The assembly includes a duct wherein an annular or tubular heat exchanger is positioned in-line with an axial fan. The assembly forces air through fins of the heat exchanger to reduce fluid temperature of fluid passing through channels in the heat exchanger. The annular design of the heat exchanger allows for improvements over prior art.

As used herein, the terms “axial” or “axially” refer to a dimension along a longitudinal axis of an engine. The term “forward” used in conjunction with “axial” or “axially” refers to moving in a direction toward the engine inlet, or a component being relatively closer to the engine inlet as compared to another component. The term “aft” used in conjunction with “axial” or “axially” refers to moving in a direction toward the engine outlet, or a component being relatively closer to the engine outlet as compared to an inlet.

As used herein, the terms “radial” or “radially” refer to a dimension extending between a center longitudinal axis of the engine and an outer engine circumference. The use of the terms “proximal” or “proximally,” either by themselves or in conjunction with the terms “radial” or “radially,” refers to moving in a direction toward the center longitudinal axis, or a component being relatively closer to the center longitudinal axis as compared to another component. The use of the terms “distal” or “distally,” either by themselves or in conjunction with the terms “radial” or “radially,” refers to moving in a direction toward the outer engine circumference, or a component being relatively closer to the outer engine circumference as compared to another component.

As used herein, the terms “lateral” or “laterally” refer to a dimension that is perpendicular to both the axial and radial dimensions.

All directional references (e.g., radial, axial, proximal, distal, upper, lower, upward, downward, left, right, lateral, front, back, top, bottom, above, below, vertical, horizontal, clockwise, counterclockwise) are only used for identification purposes to aid the reader's understanding of the present invention, and do not create limitations, particularly as to the position, orientation, or use of the invention. Connection references (e.g., attached, coupled, connected, and joined) are to be construed broadly and may include intermediate members between a collection of elements and relative movement between elements unless otherwise indicated. As such, connection references do not necessarily infer that two elements are directly connected and in fixed relation to each other. The exemplary drawings are for purposes of illustration only and the dimensions, positions, order and relative sizes reflected in the drawings attached hereto may vary.

Referring now to FIG. 1, a perspective view of a tubular heat exchanger with integral fan assembly 10 is depicted. The assembly 10 includes a duct 12 which is depicted as circular in cross-section. The duct 12 may be of various cross-sectional shapes including the circular or annular shape depicted, but not limited to such. Additionally, other duct shapes, such as square, rectangular, octagonal or other geometric polygons or otherwise may be utilized. The duct 12 includes a forward inlet end 14 and an outlet end 16 defining a flow path 18 therebetween, wherein airflow 20 moves between the inlet 14 and the outlet 16. Within the duct 12 is an integral fan 24. The fan 24 may be located at a forward inlet end of the duct 12 or at the outlet end 16.

Disposed between the inlet end and outlet end 14, 16 of the duct 12 is a tubular heat exchanger 30. The heat exchanger 30 includes a fluid inlet 31, fluid outlet 34 and one or more extrusion core segments 50 (FIG. 3) extending between the inlet and outlet 31, 34.

Referring now to FIG. 2, an exemplary axial fan 24 is depicted. The fan 24 includes a rotor or disc 26 or alternatively, may be a blisk wherein the discs and blades 28 are integrally formed together. Although not shown in this view, the fan 24 may also include a nose cone to direct air radially outward, as well as protect the fan 24 from foreign objects.

The fan 24 may be bolted or welded to an end of a duct 12. Alternatively, the fan may be positioned intermediate to the ends 14, 16 within the duct 12 according to some embodiments. In the exemplary embodiment, the fan 24 is connected at an end of the duct 12. In the previous embodiment of FIG. 1, the fan 24 is located within the duct 12. Either embodiment is within the scope of the present disclosure.

Referring now to FIG. 3, a perspective view of an exemplary annular heat exchanger is depicted. According to the depicted embodiment, an upper half 32 of the annular heat exchanger 30 is shown. However, in use, the half or portion 32 would be combined with a lower half or portion (not shown) to provide an assembly. The heat exchanger 30 may be one piece or multiple portions 32. The heat exchanger 30 is disposed within the duct 12 (FIG. 1) as previously described and the airflow 20 passes through heat exchanger 30 to remove heat from a fluid flow within the heat exchanger 30.

The heat exchange portion 32 includes an inlet end or face 41, an outlet end or face 43 and a passageway 45 therebetween. The passageway 45 is coaxial with the flowpath 18 (FIG. 1) so that the airflow 20 passes between the inlet 41 and the outlet 43.

At each of the inlet 41 and the outlet 43 is a flange 40 which allows for connection to the duct 12 or to the fan 24 or both. Axially extending between the flanges 40 and the inlet and outlet 41, 43 are manifolds 46, 47 which receive engine cooling fluids and direct the fluid into extrusion core segments 50.

The heat exchanger portions 32 further comprise a plurality of extrusion core segments 50 which extend between an axially forward end 42 and an axially aft end 44. The extrusion core segments 50 include fluid channels and heat exchange fins that are disposed in the flowpath 18 and bathed in airflow 20 moving through the duct 12. This results in removal of heat from fluid passing through the extrusion core segments 50. In addition to extending the extrusion core segment 50 in an axial direction, the extrusion core segments 50 are stacked on top of one another in a radial direction to increase the radial dimension of the heat exchanger portion 32. Thus, the heat exchanger portions 32 are formed of annular ring sections or segments which span a flow duct and allowing penetration flow for heat exchange. The extrusion core segment 50 laid in the radial direction provide for a cylindrical mesh which allows heat transfer as air flows through the heat exchanger 30. The heat exchanger 30 of the embodiment shown is generally cylindrical however other shapes may be utilized to conform the heat exchanger to a duct wherein the exchanger 30 is positioned. Moreover, the structure may be tapered in a radial direction across an axial length. Additionally, other geometric shapes than the circular cross-section depicted may be also utilized. Additionally, the heat exchanger 30 may be curved to match a curved axis of a curved duct, as previously noted.

Referring now to FIG. 4, a circumferentially oriented view is shown of one embodiment of an extrusion core segment 50. The extrusion core segment 50 includes an extrusion body 52 having a first end 54 and an opposite second end (not shown) which is spaced circumferentially from the first end 54. The spacing may vary depending on circumferential length of the extrusion core segment 50. This is not limited. Extrusion body 52 also includes a radially inner surface 56, a radially outer surface 58.

The airflow 20 is also shown passing over the extrusion body 52 and relative to fins 70 extending from the extrusion body 52. The plurality of cooling fins 70 extend in a radial direction from the radially inner surface 56. This embodiment is referred to as a single sided fin arrangement. Alternatively, fins 70 may extend from the radially outer surface 58. As will be described further herein, the extrusion core segment 50 is capable of being embodied by a double sided fin embodiment as well.

Extrusion body 52 also includes a plurality of cooling channels 60 extending lengthwise (circumferentially) through each arcuate extrusion core segment 50. Cooling channels 60 are selectively sized to receive fluid to be cooled therethrough. In the exemplary embodiment, extrusion body 52 includes a plurality of cooling channels 60 extending circumferentially. In the depicted embodiment, there may be three channels however, this is non-limiting and merely exemplary. Various numbers of channels 60 may be utilized based on the axial length of the extrusion body 52. Likewise, the channels 60 may vary in size and shape depending on the cooling desired and the volume of fluid being pumped through the extrusion body 52.

In the exemplary embodiment, channels 60 have a geometrically shaped cross-sectional profile. According to the instant embodiment, the shape is generally rectangular with curved corners to improve flow characteristics. Alternatively, cooling channels 60 have a cross-sectional profile that is some other shape such as for example, circular, square, oval, triangular or the like. Furthermore, the channels 60 may be parallel and may all carry the same fluid, or they may be segregated into multiple groups where each group carries a different cooling fluid used for different cooling purposes. For example, one group may carry lubrication fluid for the bearings, and another group might carry a separate cooling fluid for electronic apparatuses in the engine.

With brief reference to FIG. 5, an alternative extrusion body 152 is depicted. The axial length, in the direction of the airflow 20, is greater than the embodiment of FIG. 4. Accordingly, a plurality of channels 160 are depicted which is greater than the number of channels of the previous embodiment. The channels 160 extend circumferentially through each arcuate extrusion body 152 of extrusion core segment 150 and are selectively sized to receive fluid therethrough. In the exemplary embodiment, channels 160 have a substantially rounded rectangular cross-sectional profile. Alternatively, channels 160 may have a cross-sectional profile that is other than rectangular such as for example, circular. Furthermore, channels 160 are parallel channels that may all carry the same fluid, or they may be segregated into multiple groups where each group carries a different cooling fluid used for different cooling purposes. For example, one group may carry lubrication fluid for the bearings, and another group might carry a separate cooling fluid for electronic apparatus on the engine.

In the instant embodiment, additional channels 161 are located radially inwardly from channels 160 and closer to the plurality of fins 70. The channels 161 may be utilized which may be for a second fluid or may be used when additional cooling is needed. Alternatively, when less cooling is needed such as in extremely cold climates or at startup in cold climates, the channels 160 may be utilized. The channels 60, 160 may be of same or different slopes, sizes and orientations.

In the exemplary embodiment, extrusion core segment 150 is formed such that cooling channels 161 are positioned radially inward from channels 160 and radially outward from cooling fins 70. Alternatively, cooling channels 161 may be positioned radially outward from channels 160. Generally, cooling channels 160, 161 may be positioned at any location within extrusion body 152 that facilitates operation of heat exchanger assembly as described herein. However, it may be desirable to position the cooling channels 161 more proximate to the fins to effectuate more efficient cooling of fluid and in most cases, the cooling channels 161 will be disposed between the channels 160 and the fins 70.

Referring now to both FIGS. 4 and 5, each of the extrusion core segments 50, 150 have a plurality of cooling fins 70. With reference to FIG. 4, a plurality of fins are arranged in circumferential rows 72 and axial rows 74. The fins 70 are generally extending in a radial direction inwardly.

In the exemplary embodiment, cooling fins 70 extend along a width in the axial direction of extrusion body 52 between upstream end and downstream end. The fins 70 extend axially in parallel with the airflow direction and are arranged circumferentially around inside or outside surfaces of the bodies. In the exemplary embodiment, cooling fins 70 are coupled to extrusion body 52 such that each of the cooling fins 70 is substantially perpendicular to channels 161 and such that the direction of the fluid channeled through openings 161 is approximately perpendicular to the direction of airflow channeled through cooling fins 70. More specifically, cooling fins 70 are aligned providing paths for the airflow 20 passing through the fins 70. Alternatively, the fins 70 may be angled relative to the purely axial direction of the duct 12 since airflow 20 may rotate about the duct 12.

According to the instant embodiments, the extrusion core segment 50, 150 is formed in an extrusion process such that cooling fins 70 are integrally formed with extrusion body 52, 152. A fin cutting process, for example, is then conducted to form the cooling fins 70, for example in a direction perpendicular to the extrusion direction. Optionally, cooling fins 70 may be coupled to extrusion body 52, 152 utilizing a welding or brazing procedure, for example. In the exemplary embodiment, extrusion body 52, 152 and cooling fins 70 are fabricated from a metallic material, such as aluminum. Other metals or alloys may be used however.

To facilitate channeling a fluid through extrusion body 52, extrusion core segment 150 also includes at least one inlet connection 32 and at least one outlet connection 34 (FIG. 1). The inlet and outlet may be in flow communication with the manifolds 46 depicted in FIG. 2. In the exemplary embodiment, connections 32, 34 (FIG. 1) are each coupled to channels 60 of extrusion core segment 50 via a manifold 46.

The extrusion core segment 50, 150 can be configured to have one or a plurality of fluid circuits, each with an inlet connection and an outlet connection. These circuits can each have a separate and distinct purpose and carry non-mixing fluids, which are used for cooling different apparatus.

Referring now to FIGS. 6 and 7, core segments 250, 350 are depicted. These extrusion core segments 250, 350 are both formed with fins 70 on two sides of the core segment extrusion body 252, 352. Accordingly, these embodiments are referred to as double sided fins. With reference first to FIG. 6, the extrusion core segment 250 includes an extrusion body 252 which extends circumferentially about the duct 12. The circumferential length may vary either extending entirely about the duct or some preselected circumferential length. The extrusion body 252 also has an axial length in the direction of the airflow 20. Across the axial length are a plurality of flow paths or channels 260 which extend in a circumferential direction through the extrusion body 252 allowing flow of for example, oil needing cooling or alternatively, a cooling fluid utilized to reduce air temperature moving through the heat exchanger. The extrusion core segment 250 also includes a plurality of fins 70 extending in a radial direction. The fins 70 are formed in a cutting process from a single piece of material which also defines the extrusion body 252. By cutting the fins 70 from the extrusion, the process of brazing multiple fins to the extrusion body 52 is eliminated and therefore the costs for producing the extrusion core segments 50 may be reduced. The extrusion body 252 is generally extruded and in a subsequent process, the step carves the fins 70 from the single piece of metal. The fins 70 may be carved in one or more directions, for example as shown in the axial and circumferential directions. Alternatively, the fins 70 may extend at some angle similar to a helical fin structure as well. Additionally, the fins 70 are shown extending radially from the body so as to extend outwardly therefrom the extrusion body 252. However, according to other embodiments fins 70 may be carved so as to extend either radially inward or both radially inward and outward.

As described earlier, the extrusion body 252 includes a plurality of flow paths or channels 260 for a fluid to be cooled or a fluid to cool the airflow. As with the previous embodiments, the axially forwardmost flow channel 260 alternatively according to one embodiment may be a blank. That is to say, the forwardmost flow path may not receive any fluid flow therein so as to preclude fluid leakage from foreign objects entering the heat exchanger 30, also referred to as foreign object damage. Additionally, at this forward end of the extrusion core segment 50, relative to the airflow 20, a leading edge 253 of the extrusion body 52 is curved to improve aerodynamics of the extrusion core segment 50. Likewise, the leading edge may have an increased material thickness to decrease damage from foreign object in the airflow path encountering the heat exchanger 30. The trailing edge may alternatively be curved for improving aerodynamic performance. Various other shapes or arrangements may be utilized for a leading edge to improve overall aerodynamics of the entire assembly of the heat exchanger 30.

With reference to FIG. 7, the extrusion core segment 350 comprises a core extrusion body 352. The fins 70 extend from two sides of the body as previously described. The embodiment depicts that various size of extrusion body 352 may be utilized as well as various numbers of channels 360 as compared to other embodiments. The fins 70 are shown extending radially but may include some twist at an angle to a purely axial direction 20. The channels may vary in size, shape and orientation.

With reference now to FIG. 8, a heat exchanger with integral fan assembly 110 is shown. An embodiment of the single sided fin extrusion core segment, for example 50, 150 is shown. The duct 112 has an inlet and an outlet 114, 116. The fins 70 extend radially inwardly into a flowpath 18 wherein airflow 20 moves to remove heat from the fluid passing through the channels 60. The extrusion core segment 50, 150 is disposed about the interior of the duct 12 and according to the instant embodiment, the fan 24 is disposed forward of the heat exchanger fins 70 for pushing air therethrough.

With reference now to FIG. 9, an alternate embodiment of a heat exchanger with integral fan assembly 210 is depicted wherein the duct 212 is shown and the double sided fin extrusion core segment 250, 350 (FIGS. 6, 7) is shown. The duct 212 includes an inlet 214 and an outlet 216. The fins 70 extend in two radial directions in order to form two flowpaths, an inner flowpath 218 and an outer flowpath 219. A fan (not shown) may be located upstream or downstream of the fins 70. Additionally the fan 24 may be bolted to an inlet or outlet end of the duct 212 or may be positioned within the duct 212.

The foregoing description of structures and methods has been presented for purposes of illustration. It is not intended to be exhaustive or to limit the invention to the precise steps and/or forms disclosed, and obviously many modifications and variations are possible in light of the above teaching. Features described herein may be combined in any combination. Steps of a method described herein may be performed in any sequence that is physically possible. It is understood that while certain embodiments of methods and materials have been illustrated and described, it is not limited thereto and instead will only be limited by the claims, appended hereto.

What we claim is:

1. A tubular cooler with integrated fan assembly, comprising:
a duct having an inlet end and an outlet end;
a heat exchanger disposed within said duct;
said heat exchanger having an annular shape and extending axially at least partially between said first end and said second end of said duct;
a fan disposed in flow communication with said duct, said fan forcing airflow through said heat exchanger;
said heat exchanger including:
an extrusion core body having a fluid inlet and a fluid outlet; and,
a plurality of fins extending from and integrally formed with said extrusion core body and positioned within said duct.

2. The tubular cooler with integrated fan assembly of claim 1, said extrusion core body having a plurality of circumferentially extending channels therein.

3. The tubular cooler with integrated fan assembly of claim 1 further comprising fins extending from one side of said extrusion core body.

4. The tubular cooler with integrated fan assembly of claim 1 further comprising fins extending from two sides of said extrusion core body.

5. The tubular cooler with integrated fan assembly of claim 4 further comprising an outer flow and an inner flow corresponding to said fins extending from said two sides of said extrusion core body.

6. The tubular cooler with integrated fan assembly of claim 1, said fan being disposed in said duct.

7. The tubular cooler with integrated fan assembly of claim 1, said fan being connected to said duct.

8. The tubular cooler with integrated fan assembly of claim 7, said fan being connected to one of said inlet end or said outlet end.

9. The tubular cooler with integrated fan assembly of claim 8, said fan being disposed intermediate to said inlet and said outlet.

10. The tubular cooler with integrated fan assembly of claim 1, said duct having a plurality of said heat exchangers therein.

11. The tubular cooler with integrated fan assembly of claim 1, said duct substantially having a single heat exchange extending therein.
